(19) United States
(12) Patent Application Publication
(10) Pub. No.: US 2016/0058235 A1
(43) Pub. Date: Mar. 3, 2016

(54) APPARATUS FOR INFUSION BREWING COFFEE AND RELATED METHOD

(71) Applicant: MICHAEL E BLAIR, WASHINGTON, DC (US)

(72) Inventor: MICHAEL E BLAIR, WASHINGTON, DC (US)

(21) Appl. No.: 14/473,005

(22) Filed: Aug. 29, 2014

(51) Int. Cl. A47J 31/38

(52) U.S. Cl. CPC A47J 31/38

(57) ABSTRACT

An infusion brewer is provided including piston and filter assemblies to be inserted into an infusion container. The piston assembly consists of a hollow vertical shaft, a horizontal plate with a seal situated at the edge of the plate, a seal situated at the center of the plate, and a check valve vent. The piston seals are adapted for sealing against the inner walls of the infusion container and for sealing against the filter assembly shaft. The filter assembly is positioned at the bottom of the infusion container and consists of a hollow vertical shaft and a horizontal plate with seals at the exterior edge and bottom surface. The filter assembly includes three graduated levels of filter material. The piston assembly pumps the infused extract through the filter assembly filters, thence through the filter shaft, thence through the piston shaft, into the isolated upper infused extract chamber.

### CROSS-REFERENCE TO RELATED APPLICATIONS

Refer to Application Data Sheet for reference to Provisional Patent Application number 61883334.

### BACKGROUND OF INVENTION

The present invention relates generally to apparati capable of carrying out an extraction of an infusible material, and methods of use thereof, and more particularly to an apparatus for separating an extract of an infusible material from a mixture of the extract and the infusible material, after extraction of the infusible material has taken place.

Of the many techniques for brewing coffee, connoisseurs consider the infusion process used by French press apparati to be one of the best. Even though French press infusion apparati may result in a superior, flavorful, smooth, full bodied coffee, common embodiments of the apparati have several potentially negative impacts on the finished brewed coffee. A common negative impact includes an undesirable amount of sediment in the finished coffee caused by course filters and/or leaking seals. A second negative impact occurs when the finished coffee remains in contact with the coffee grounds after the coffee is pressed and the infusion process continues to the detriment of the finished coffee flavor. Common embodiments of French press apparati filter from the top of the infusion container. Since most coffee grounds float, filtering from the top forces the grounds directly into the filter potentially causing the filter to clog. To overcome the propensity for the filter to clog, common embodiments of French press apparati provide course filter material which requires the use of very course ground coffee. Using overly course ground coffee causes an uneven infusion of the coffee that has a negative impact on the taste of the finished coffee. The course filter also increases the amount of sediment passed into the finished coffee. Many common embodiments of French press apparati have inadequate seals which allows coffee grounds to bypass the filter and enter directly into the finished coffee.

### BRIEF SUMMARY OF INVENTION

It is the goal of the present invention to overcome negative aspects of French press apparati as commonly embodied. An embodiment of an apparatus for brewing a beverage such as coffee includes an infusion container and filter and piston assemblies disposed in the infusion container. The filter assembly is positioned at the bottom of the infusion container below the floating coffee grounds permitting finer filtering and the use of finer ground coffee. As the piston assembly is depressed, the brewed coffee is forced down through the filter assembly's graduated tertiary filters, up through the filter shaft, thence down the piston assembly shaft, and into the isolated upper infused extract chamber. The edge seals are pressure assisted to inhibit coffee grounds from entering directly into the filtered coffee.

### BRIEF DESCRIPTION OF THE DRAWING

FIG. 1 depicts a vertical section of an exemplary infusion brewing apparatus according to an embodiment of the present invention, showing the piston element and the filter element in a partially plunged position inside an infusion container.

### DETAILED DESCRIPTION OF THE INVENTION

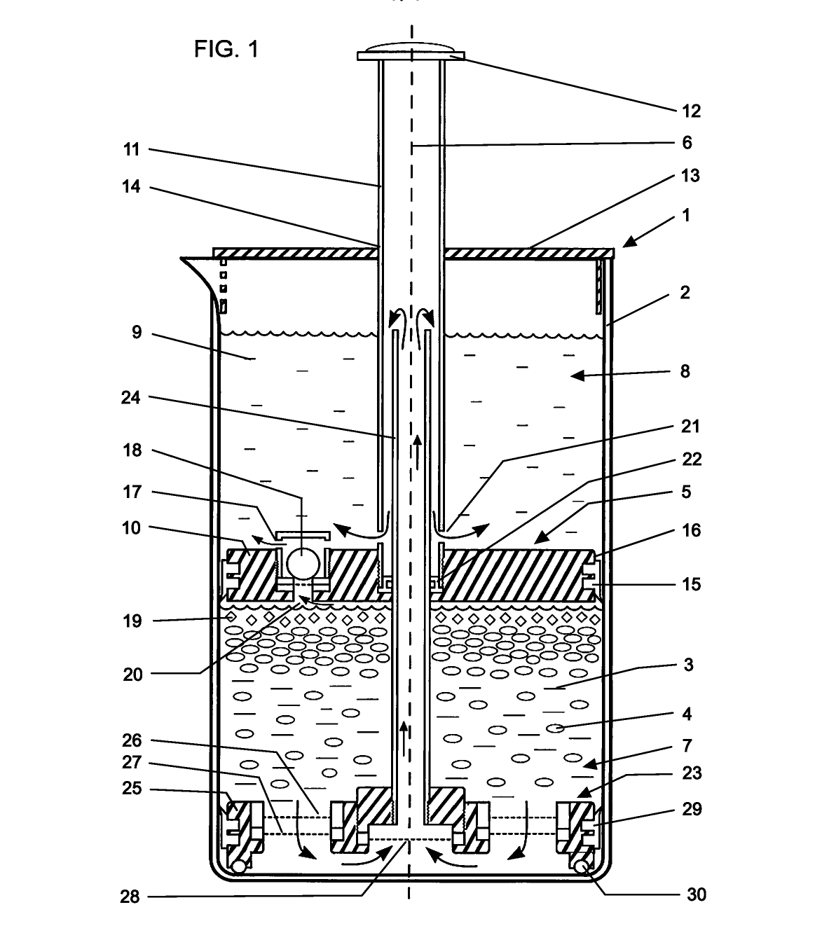

Referring to FIG. 1, an infusion brewing apparatus 1 according to an embodiment of the invention is shown configured similarly to a French press type coffee or tea making apparatus. The infusion brewing apparatus 1 comprises exemplary doubled-walled cylinder infusion container 2 containing a mixture of extract 3 and infusible material 4. Piston assembly 5 is adapted to fit within infusion container 2 of infusion brewing apparatus 1 and to be moved within infusion container 2 along a vertical axis thereof, such as central vertical axis 6, by means of piston extract transfer shaft 11. Piston assembly 5 separates and isolates infusion chamber 7 from filtered extract chamber 8. Infusion container 2 may include a double-layered wall, such as a double metal or glass wall, with a vacuum or other suitable and preferably an insulating substance between the two walls of infusion container 2, such as to reduce variations in temperature inside infusion container 2 during the extraction process. The plunging means may comprise a piston plate 10 attached to a central elongated piston extract transfer shaft 11 and optional piston knob 12, for example, which may be grasped by a user to move piston assembly 5. Infusion brewing apparatus 1 may additionally comprise a lid 13 with piston shaft lid hole 14 through which piston extract transfer shaft 11 may pass to assist in centering the piston assembly 5 and piston extract transfer shaft 11 inside infusion container 2 and prevent it from tilting. FIG. 1 shows the infusion brewing apparatus 1 in an intermediate position for separating the extract 3 from the mixture of extract 3 and infusible material 4 in infusion container 2.

In the exemplary embodiment of the present invention shown in FIG. 1, infusion container 2 comprises a substantially vertical walled cylinder container, with a substantially circular cross-section, and piston assembly 5 which is substantially circular in cross-section adapted to fit inside the cylindrical infusion container 2. Pressure assisted piston outer seal 15 is situated around the substantially circular piston outer edge 16 of piston assembly 5 to provide a seal against the cylindrical wall of infusion container 2 when piston assembly 5 is moved inside infusion container 2, to substantially prevent extract 3 or infusible material 4 from leaking around piston outer seal 15.

In embodiments of the invention including an infusion container 2, the infusion container 2 may be made from any suitable material such as one or more of: glass, plastic, ceramic, metal or other suitable material, for example. Further, piston assembly 5 and components thereof may be made from any suitable material such as one or more of: polymer, composite, metal, ceramic or other suitable materials, for example. Further, filter assembly 23 and components thereof may be made from any suitable material such as one or more of: polymer, composite, metal, ceramic or other suitable materials, for example.

Piston outer seal 15, piston inner seal 22, filter primary seal 29, and filter secondary seal 30 may comprise any suitable known seal material and/or design. Exemplary such seal designs may include single or multiple lip seals, single or multiple wiper seals, and single or multiple U-cup seal designs, for example. Suitable such single or multiple U-cup seal designs may desirably be self-energizing, such that an outer edge of the U-cup seal actively engages and seals with the inner wall of infusion container 2. Additionally, piston outer seal 15, piston inner seal 22, filter primary seal 29, and filter secondary seal 30 may comprise one or more such suitable seal materials by themselves, or alternatively, such seal materials may surround or be over-molded over a support material, such as a metal or composite support material, for example. The above-described exemplary sealing means materials and designs may also apply to sealing means incorporated in other embodiments of the invention. Piston assembly 5 may also optionally include one or more piston vent openings 17. The piston vent openings 17 are adapted to permit the flow of air out of infusion chamber 7 into filtered extract chamber 8, as piston assembly 5 is moved inside infusion container 2. Piston vent check valve assembly 18 prevents continued extraction after piston assembly 5 is fully depressed. In some exemplary embodiments of the invention, extraction of infusible material 4 may also result in the extraction of low density extractable constituents 19, such as oils or other constituents having a lower density than the remainder of extract 3, and which may typically float on top of extract 3 in infusion chamber 7. In such embodiments comprising low density extractable constituents 19, one or more optional piston vent openings 17 may also permit the flow of at least a portion of the low density extractable constituents 19 out of infusion chamber 7 through vent openings 17. According to another embodiment, vent openings 17 may also optionally include vent filters 20. Optional vent filters 20 may also be multi-staged, comprising a plurality of individual filter elements. In a further optional embodiment, one or more piston vent openings 17 may be adjustable or configurable to control the amount of air and/or low density extractable constituents 19 which may flow out of infusion chamber 7 through piston vent openings 17. Depressing piston assembly 5 pumps filtered extract 9 up through filter extract transfer shaft 24 and down piston extract transfer shaft 11, and out piston shaft ports 21 into filtered extract chamber 8. Piston assembly 5 includes piston inner seal 22 providing a seal between piston assembly 5 and filter extract transfer shaft 24.

In the exemplary embodiment of the present invention shown in FIG. 1, filter assembly 23 includes filter extract transfer shaft 24, filter plate 25 and three graduated filters, primary filter 26, secondary filter 27, and tertiary filter 28. Filter assembly 23 also includes filter primary seal 29 and filter secondary seal 30. Prior to insertion of extract 3 and infusible material 4 into infusion container 2, filter assembly 23 is positioned at the interior bottom of infusion container 2. After completion of the extraction process, filter assembly 23 provides for ease of removal of infusible material 4 from infusion container 2. In some common exemplary embodiments of the invention, filters and seals may vary from the exemplary embodiment of the present invention shown in FIG. 1.

In some common exemplary embodiments of the invention, infusion brewing apparatus 1 may be configured for extracting a hot beverage filtered extract 9 from infusible plant material 4, such as in embodiments where infusible material 4 may comprise coffee grounds, tea leaves or herbal infusibles, for example, and filtered extract 9 may comprise coffee, tea or herbal tisane, respectively

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for separating an infused extract from a mixture of an infusible material and an extract, the apparatus comprising an infusion container, filter assembly, piston assembly, and lid.

2. The apparatus according to claim 1, wherein said infusion container having one or more substantially vertical inner walls oriented substantially parallel to a vertical axis of the container.

3. The apparatus according to claim 1, wherein said filter assembly is adapted to be inserted at the bottom of the infusion container along the vertical axis thereof and consists of a filter extract transfer shaft, a plate with filter ports and filters, and seals adapted for engagement with inner walls and bottom of the infusion container.

4. The apparatus according to claim 1, wherein said piston assembly is adapted to be moved within the infusion container along the vertical axis thereof and consisting of a of a piston extract transfer shaft, a plate substantially transverse to the vertical axis including a vent check valve assembly and seals adapted to for engagement with inner walls of infusion container and filter extract transfer shaft.

5. The apparatus according to claim 3, wherein the filters consist of three increasingly fine levels of filter material through which the infused extract flows sequentially from course to fine.

6. The apparatus according to claim 4, wherein a piston extract transfer shaft is secondarily used as a plunging shaft.

7. The apparatus according to claim 4, wherein a piston assembly forces infused extract through the filter assembly filters; thence, through the filter assembly extract transfer shaft; thence, through the piston assembly piston extract transfer shaft, and thence, through the piston assembly piston shaft port into the filtered extract chamber.
